(19) United States
(12) Patent Application Publication
(10) Pub. No.: US 2013/0246099 A1
(43) Pub. Date: Sep. 19, 2013

(54) NICHE-SPECIFIC TREATMENT INFRASTRUCTURE CONTINUUM

(71) Applicants: Andrew Burki, Boynton Beach, FL (US); Samuel Campbell, Boca Raton, FL (US)

(72) Inventors: Andrew Burki, Boynton Beach, FL (US); Samuel Campbell, Boca Raton, FL (US)

(21) Appl. No.: 13/846,454

(22) Filed: Mar. 18, 2013

Related U.S. Application Data
(60) Provisional application No. 61/612,246, filed on Mar. 16, 2012.

(51) Int. Cl. G06F 19/00

(52) U.S. Cl. CPC G06F 19/3443
USPC 705/3; 705/2

(57) ABSTRACT

A niche-specific treatment infrastructure continuum includes two or more treatment infrastructures each providing a specific level of treatment for a cluster of traits and to a corresponding niche population. The treatment is defined by a treatment model developed using empirical-based research data resulting from research for the cluster and upon the corresponding niche population. A research facilitator is configured to generate suggestions to research facilities and/or researchers to perform empirical-based research specific to the cluster of traits and/or upon the corresponding niche population. A patient selector is configured to select a niche patient population from a population of potential patients based on selection criteria specifying a cluster of traits, the traits including at least one Axis I disorder, at least one Axis IV problem, and at least two additional demographic attributes.

### CROSS-REFERENCE TO RELATED APPLICATIONS

This application claims the benefit of U.S. Provisional Application No. 61/612,246, entitled “NICHE-SPECIFIC TREATMENT INFRASTRUCTURE CONTINUUM”, filed on Mar. 16, 2012.

### BACKGROUND

1. Field of the Invention

The present invention relates generally to infrastructure for the treatment of a cluster of traits.

2. Related Art

There are different levels of mental-health care: micro-level; meso-level and macro-level. At the micro-level, the mental-health care is specific to the disorder-characteristics of the individual. Micro-level care typically takes the form of one-on-one interventions utilizing a specific therapeutic technique or a blend of such techniques for a given individual provided by a counselor who becomes progressively more familiar with the given individual as the micro-level treatment continues. At the meso-level, the mental-health care is specific to one, or perhaps two or three, common characteristic(s) of a group of people, e.g., a group comprised of teenagers who are drug dependent, a group comprising teenage boys who are alcohol dependent. Meso-level care typically takes the form of group-based therapeutic techniques provided by a counselor who becomes progressively more familiar with the common characteristics of the group as the meso-level treatment continues. At the macro-level, the mental-health care is specific to supporting the needs of a facility that provides either micro-level and/or meso-level health care. For the purposes of the present description, macro-level mental-health care typically takes the form of the administrative organizations and physical facilities, e.g., hospitals buildings and medical equipment, residential buildings, etc.

The scope of mental-healthcare provided to a given patient is typically informed by the Diagnostic and Statistical Manual of Mental Disorders (DSM) published by the American Psychiatric Association, which provides a common language and standard criteria for the classification of mental disorders. The current version is the DSM-IV-TR (fourth edition, text revision). The DSM-IV-TR is organized into a five-part ‘axis’ system. Axis I describes ‘clinical disorders.’ Axis II covers personality disorders and intellectual disabilities. Axis III covers relevant physical diseases and/or conditions. Axis IV describes psychosocial and environmental problems. Axis V is a score between 0 and 100 covering the individual's Global Assessment of Functioning

There are mental-healthcare treatment infrastructures that focus their treatments upon a specific Axis I disorder. Of those, infrastructures that treat addiction are typically based upon a Twelve-Step Model. Some of these infrastructures offer treatment for patients with a Dual Diagnosis, i.e., a diagnosis of two Axis I disorders. Examples of these infrastructures include: The Betty Ford Center; Sober College; Shadow Mountain Academy; and the Living Sober Program. The Betty Ford Center is a specialized hospital that provides inpatient, outpatient, and day treatments for alcohol and other drug addictions. Sober College (www.sobercoilege.com) is located in Woodland Hills, Calif., and is a residential drug rehabilitation facility for young adults ages 17-26 who are struggling with drug and/or alcohol abuse. Sober College is a long-term treatment program that operates according to the principle that the longer a young adult can be in a treatment environment, the better the chances are for lasting success. Shadow Mountain Academy (www.shadowmountainacademy.com) is a residential rehabilitation and sober living facility for men ages 17-24 who are ‘new in recovery,’ which is located in a remote rural area, and which offers a three-tiered program of recovery that develops the habit of sobriety. The Living Sober Program (www.livingsober.com) by National Therapeutic Services (NTS) is a multi-phase treatment program offering both residential and out-patient treatment services.

### SUMMARY

In accordance with one aspect of the present invention, there is provided a niche-specific treatment infrastructure continuum of two or more treatment infrastructures each providing a specific level of treatment for a cluster of traits and to a corresponding niche population, said treatment defined by a treatment model developed using empirical-based research data resulting from research for the cluster and upon the corresponding niche population.

In accordance with another aspect of the present invention, there is provided a research facilitator configured to generate suggestions to research facilities and/or researchers to perform empirical-based research specific to a cluster of traits and/or upon a corresponding niche population, wherein said suggested research is based on data resulting from previously-performed research and treatment conducted for the cluster and upon the corresponding niche population.

In accordance with another aspect of the present invention, there is provided a patient selector configured to select a niche patient population from a population of potential patients based on selection criteria specifying a cluster of traits, the traits including at least one Axis I disorder, at least one Axis IV problem, and at least two additional demographic attributes.

In accordance with another aspect of the present invention, there is provided a treatment model developer configured to develop treatment models for performing a specific level of treatment for a cluster of traits and a corresponding niche population, wherein said treatment model is developed based on data resulting from previously performed treatment and empirical-based research conducted for the cluster and upon the corresponding niche population.

In accordance with another aspect of the present invention, there is provided a method of treating a cluster of traits, the method comprising: identifying an original population of persons (OPP) suffering from the cluster of traits including at least one Axis I disorder and at least one Axis IV problem; culling the OPP according to at least two additional demographic attributes thereby to form a niche population (NP); and matching the NP with a treatment infrastructure specialized for treating the traits cluster.

In accordance with another aspect of the present invention, there is provided a method of facilitating research on a cluster of traits, the method comprising: defining a traits cluster as including at least one Axis I disorder, at least one Axis IV problem and at least two additional demographic attributes; treating a niche population (NP) of cluster sufferers with an arsenal of therapies; receiving compensation for the treating; dedicating a portion of the compensation to a research-fund; and drawing upon the research-fund to fund research on the cluster by a research entity.

In accordance with another aspect of the present invention, there is provided a method of invoicing for treatment of a cluster of traits, the method comprising: defining a cluster of traits as including at least one Axis I disorder, at least one Axis IV problem and at least two additional demographic attributes; treating a niche population (NP) of cluster sufferers with an arsenal of therapies; wherein a member of the NP progresses through a continuum of treatment infrastructures in which patient recovery is characterized by a decreasing level of NP-specific therapies and a corresponding increasing level of NP-specific life-skills assistance; invoicing, during progression through the continuum, at a profit margin; and invoicing, during a relapse, at cost.

### BRIEF DESCRIPTION OF THE DRAWINGS

Embodiments of the present invention are described below with reference to the attached drawings, in which:

FIG. 1 illustrates a block diagram of a niche-specific treatment infrastructure continuum according to an embodiment of the present invention;

FIG. 2 is a plot of relative levels of niche-specific treatment therapy(ies) and life-skills assistance provided via different infrastructures of a niche-specific treatment infrastructure continuum, e.g., as in FIG. 1, according to another embodiment of the present invention;

FIG. 3A illustrates a block diagram of an engine for powering a niche-specific treatment infrastructure continuum, according to another embodiment of the present invention;

FIG. 3B illustrates a block diagram of a patient selector system of the niche-specific-treatment infrastructure-continuum engine of FIG. 3A, according to another embodiment of the present invention;

FIG. 3C illustrates a block diagram of a treatment model developer system of the niche-specific-treatment infrastructure-continuum engine of FIG. 3A, according to another embodiment of the present invention;

FIG. 3D illustrates a block diagram of an empirical-based research facilitator system of the niche-specific-treatment infrastructure-continuum engine of FIG. 3A, according to another embodiment of the present invention; and

FIGS. 4A-4G are sequence diagrams illustrating operation of a niche-specific treatment infrastructure continuum, e.g., as in of FIG. 1, according to another embodiment of the present invention.

### DETAILED DESCRIPTION

Aspects of the present invention are generally directed towards a treatment infrastructure continuum, and towards an engine that powers the same. The infrastructure continuum includes two or more treatment infrastructures each providing a specific level of treatment for a cluster of traits and to a corresponding niche population (NP). The NP is determined by: identifying an original population of persons (OPP) suffering from the cluster of traits including at least one Axis I disorder and at least one Axis IV problem; and culling the OPP according to at least two additional demographic attributes thereby to form the NP. Then the NP is matched with the treatment infrastructure continuum that is specialized for treating the cluster of traits.

An example of a cluster of traits is an Axis I substance abuse disorder, an Axis IV problem with employment, a work history as a teacher and residence within reasonable proximity to the continuum. Alternatives of such this cluster would be for people who are plumbers rather than teachers, or who are electricians rather than teachers. Another example of a cluster of traits is an Axis I eating disorder, an Axis IV problem of education disruption, an attribute of endeavoring resume school attendance, and an attribute of age in the range of about 18-29 years.

Another example of a cluster of traits is an Axis I posttraumatic stress disorder (PTSD) without an Axis I substance abuse disorder, an Axis IV problem of education disruption, an attribute of being a veteran and an attribute of endeavoring to enroll in an education program, e.g., under the GI Bill. An alternative to this example is nearly the same except that there also is an Axis I substance abuse disorder.

Another example of a cluster of traits is an Axis I posttraumatic stress disorder (PTSD), an Axis III traumatic brain injury (TBI), an Axis IV problem of social interaction impairment, an attribute of being a veteran and an attribute of endeavoring to enroll in an education program, e.g., under the GI Bill. An additional attribute may be an age in the range of about 18-29 years old. An alternative to this example is nearly the same except that there is an Axis III limb amputation instead of, or in addition to, the TBI.

Another example of a cluster of traits is an Axis I substance abuse disorder, an Axis IV problem of bereavement, an attribute of being age about 60 or older, and an attribute of being female. Another example of a cluster of traits is an Axis I substance abuse disorder, an Axis IV problem of education disruption, an attribute of speaking English as a second language, and an attribute of age in the range of about 18-29 years.

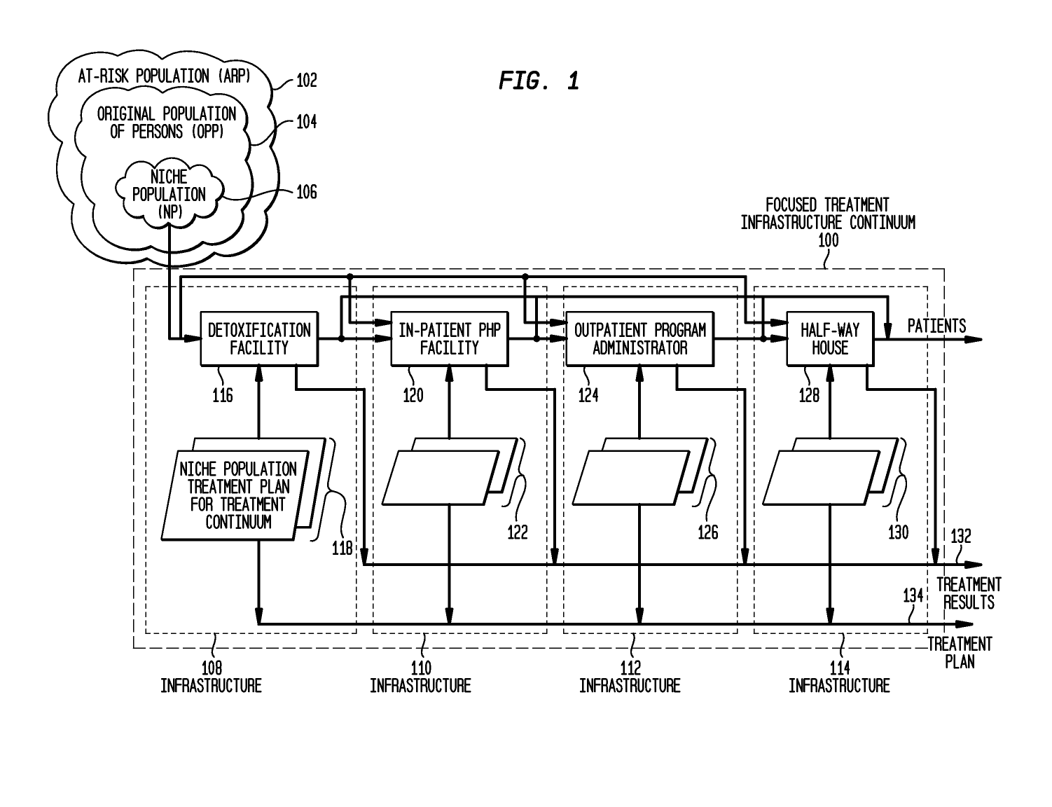

FIG. 1 illustrates a block diagram of a niche-specific treatment infrastructure continuum 100 according to an embodiment of the present invention.

In FIG. 1, continuum 100 includes a detoxification infrastructure 108, an in-patient partial hospitalization (PHP) infrastructure 110; an out-patient infrastructure 112; and a transitional residential infrastructure 114. Alternatively, fewer or a greater number of infrastructures may be included in continuum 100. Patients moving through continuum 100 are members of a niche population (again, NP) 106. NP 106 is a subset of an original population of persons (OPP) 104, which itself is a subset of an at-risk population (ARP) 102.

Progress through continuum 100 generally moves a patient from detoxification infrastructure 108 to in-patient partial hospitalization (PHP) infrastructure 110 to out-patient infrastructure 112 and/or to transitional residential infrastructure 114 with an aspiration that the patient will move from one infrastructure to the next in as short a duration as is clinically appropriate. For example, a typical duration of a stay in detoxification infrastructure 108 is about 3-10 days. For example, a typical duration of a stay in PHP infrastructure 110 is no more than about one month unless a longer duration is clinically necessary. For example, a typical duration of participation in out-patient infrastructure 112 is about 6-12 weeks. For example, a typical duration of a stay in transitional residential infrastructure 114 is about 6 months unless a longer duration is clinically necessary.

Detoxification infrastructure 108 includes a detoxification facility 116 and a corresponding database 118 of NP-specific and infrastructure-specific treatment plans including an arsenal of corresponding treatment therapies and an arsenal of corresponding life-skills assistance. Detoxification facility 116 includes physical structures (e.g., one or more buildings, corresponding furnishings and/or medical equipment) and a commensurate staff of individuals to implement the NP-specific and infrastructure-specific treatment plans.

In-patient PHP infrastructure 110 includes an in-patient facility 120 and a corresponding database 122 of NP-specific and infrastructure-specific treatment plans including an arsenal of corresponding treatment therapies and an arsenal of corresponding life-skills assistance. In-patient facility 120 includes physical structures (e.g., one or more buildings, corresponding furnishings and/or medical equipment) and a commensurate staff of individuals to implement the NP-specific and infrastructure-specific treatment plans.

Out-patient infrastructure 112 includes an out-patient facility 124 and a corresponding database 126 of NP-specific and infrastructure-specific treatment plans including an arsenal of corresponding treatment therapies and an arsenal of corresponding life-skills assistance. Out-patient facility 124 includes physical structures (e.g., one or more buildings, corresponding furnishings and/or medical equipment) and a commensurate staff of individuals to implement the NP-specific and infrastructure-specific treatment plans. In some circumstances, one or more levels of outpatient care may be differentiated, e.g., based on the number of hours per week that a client receives outpatient services. For example, one or more thresholds (in units of number of hours of treatment per week) might be set to differentiate between a standard level of outpatient services and one or more progressively more intensive levels of outpatient services, respectively. In FIG. 1, out-patient facility 124 and corresponding database 126 of NP-specific and infrastructure-specific treatment plans includes all such levels of outpatient-services differentiation. Alternatively, separate instances (not illustrated) of outpatient facility 124 and associated database 126 of NP-specific and infrastructure-specific treatment plans may be provided corresponding to various levels of outpatient services.

Transitional residential infrastructure 114 includes a transitional residential facility 128 and a corresponding database 130 of NP-specific and infrastructure-specific treatment plans including an arsenal of corresponding treatment therapies and an arsenal of corresponding life-skills assistance. Transitional residential facility 128, e.g., a half-way house, includes physical structures (e.g., one or more buildings and corresponding furnishings) and a commensurate staff of one or more individuals to implement the NP-specific and infrastructure-specific treatment plans.

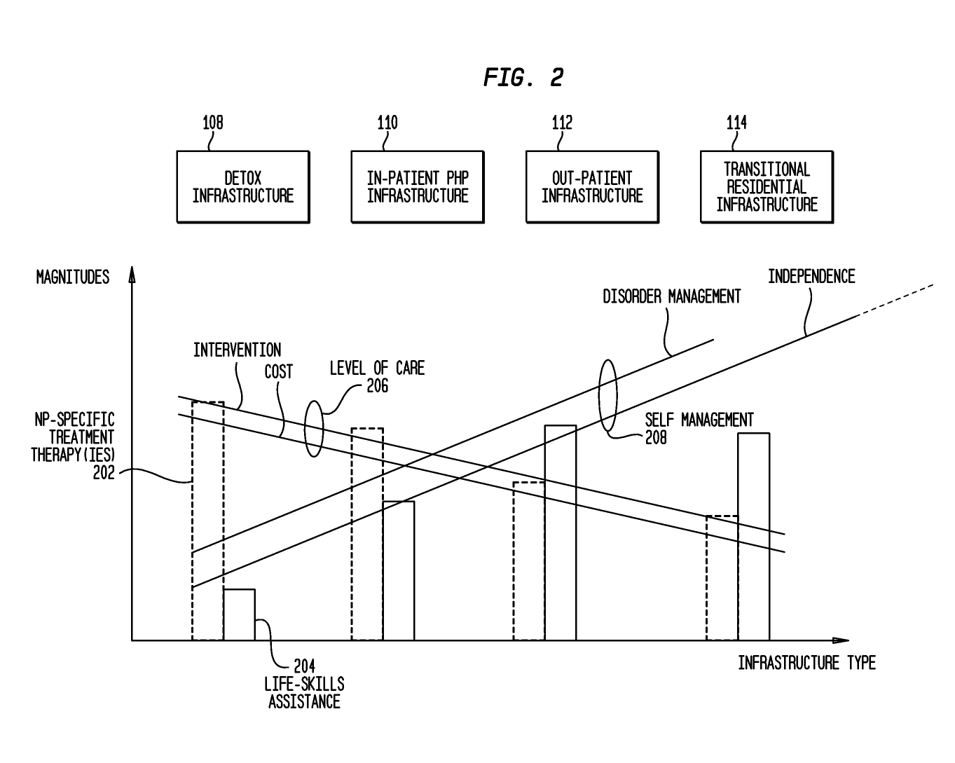

FIG. 2 is a plot of relative levels of niche-specific treatment therapy(ies) and life-skills assistance provided via different infrastructures of a niche-specific treatment infrastructure continuum, e.g., continuum 100 of FIG. 1, according to another embodiment of the present invention.

In FIG. 2, the abscissa (x-axis) represents the type of infrastructure in continuum 100 and the ordinate (y-axis) represents a magnitude of care that is provided. The magnitude of NP-specific treatment therapy(ies) is greatest for detoxification infrastructure 108 and decreases progressively for each of in-patient PHP infrastructure 110, out-patient infrastructure 112; and a transitional residential infrastructure 114, as indicated by the trend lines for intervention and cost called out by the label “Level of Care” 206. Conversely, the magnitude of life-skills assistance is lowest for detoxification infrastructure 108 and increases progressively for each of in-patient PHP infrastructure 110, out-patient infrastructure 112; and a transitional residential infrastructure 114, as indicated by the trend lines for disorder management and independence called out by the label “Self Management” 208.

Life-skills assistance (also referred to as case management) includes services that assist a member of the NP with regaining a lost direction or establishing a new direction in his life. An example of such a direction is education. For the purposes of the present description, an educational program includes at least one of a program of studies provided by a degree-granting institution, a professional certification program of studies and a trade-school program of studies. Continuing the example, life-skills assistance can include a service that assists with enrollment in an educational program, a service that assists with transferring credits from one educational program to another, a service that assists with registering for one or more classes in an educational program, a service that assists with registering for remedial classes to be taken in preparation for requesting enrollment in an educational program, a service that assists with registering for a general educational development (GED) test, a service that assists with academic tutoring; a service that assists with standardized-test preparation, a service that assists with obtaining a Visa, a service that assists a member of the NP with identifying extracurricular activities, (e.g., Y200 yoga certification, habitat for humanity, etc.), a service that assists the member of the NP with involving himself or herself with one or more of the identified extracurricular activities, e.g., in order to enhance a forthcoming application to a college/university by the member of the NP, a service that assists with placement in sober dormitories upon completion of the continuum of care by the client, etc. Regarding Visa assistance, for example, the infrastructures that comprise continuum 100 can all be located physically within one country. Alternatively, continuum 100 may include infrastructures that are located in two or more different countries. In a circumstance that a member of the NP is not a citizen of the country in which a given infrastructure of continuum 100 is located, then the Visa-assistance service assists the non-citizen member of the NP with obtaining a Visa needed for staying at or attending the given infrastructure. An example of such a Visa is a Student Visa, e.g., an F-1 Student Visa.

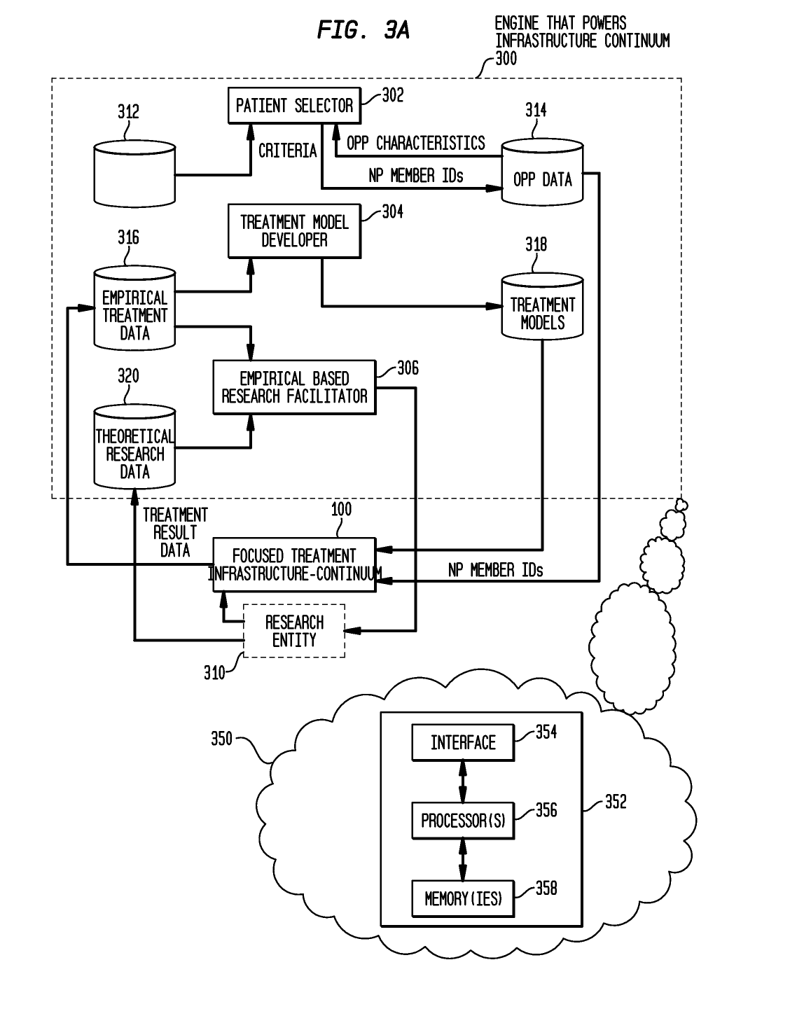

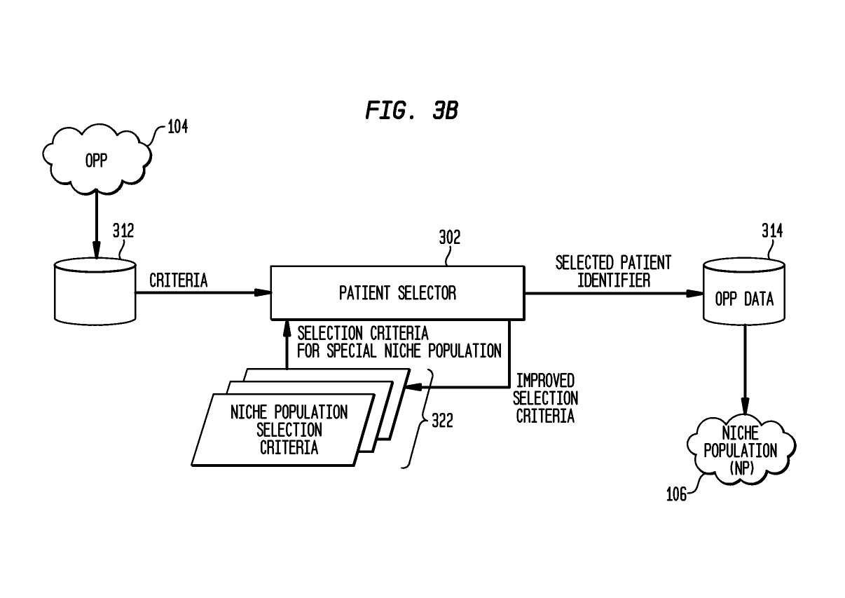

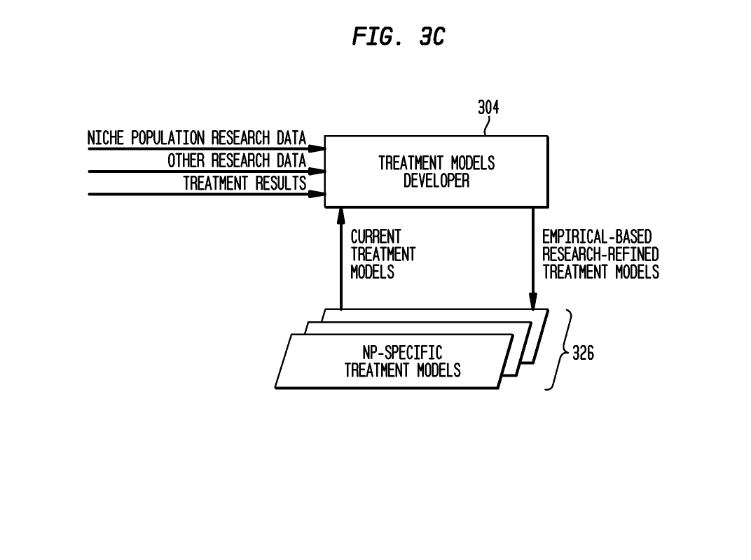

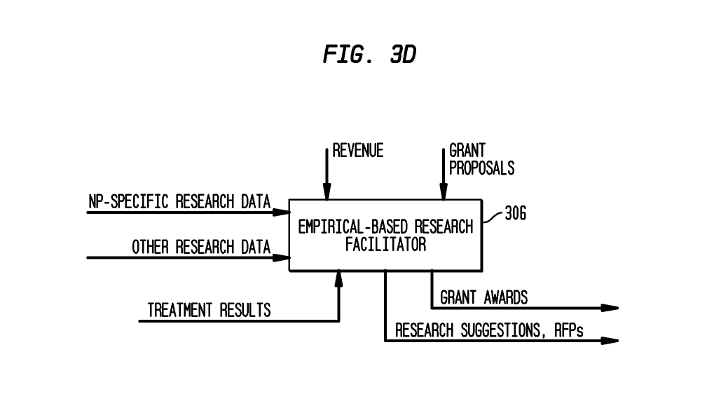

FIG. 3A illustrates a block diagram of an engine 300 for powering a niche-specific treatment infrastructure continuum, according to another embodiment of the present invention.

In FIG. 3A, engine 300 includes a patient selector system 302, a treatment model developer system 304 and an empirical-based research facilitator system 306. Engine 300 also includes a database 312 and a database 314. Database 312 includes data regarding ARP 102 that includes criteria for use by patient selector system 302. Such criteria includes some of the traits of the cluster including at least one Axis I disorder and at least one Axis IV problem. Database 314 characteristics of OPP 106 that are used by patient selector system 302. Such characteristics include others ones of the traits of the cluster including and at least two additional demographic attributes. Database 314 also includes identification information (IDs) for members of NP 106, which it provides to patient selector system 302 and to continuum 100.

Engine 300 also is illustrated as including a database 316 of empirical treatment data 316 based upon results of treatments provided to NP 106. Database 316 provides such data to treatment model developer system 304 and to research facilitator system 306. Developer system 304 uses the data to develop infrastructure-specific treatment plans including arsenals of corresponding treatment therapies and arsenals of corresponding life-skills assistance. Data representing the infrastructure-specific treatment plans is stored in a database 318 of treatment models, and correspondingly output to continuum 100. Data representing results of administering the infrastructure-specific treatment plans to NP 106, i.e., treatment results data (which is empirical data), is fed back from continuum 100 into database 316.

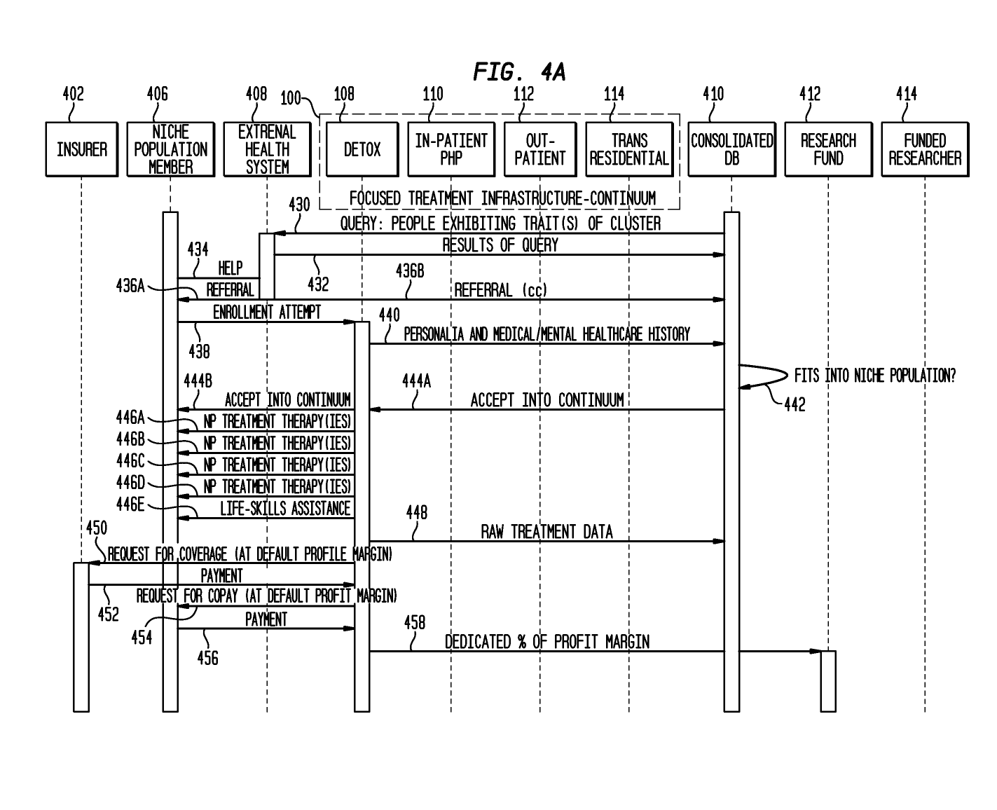

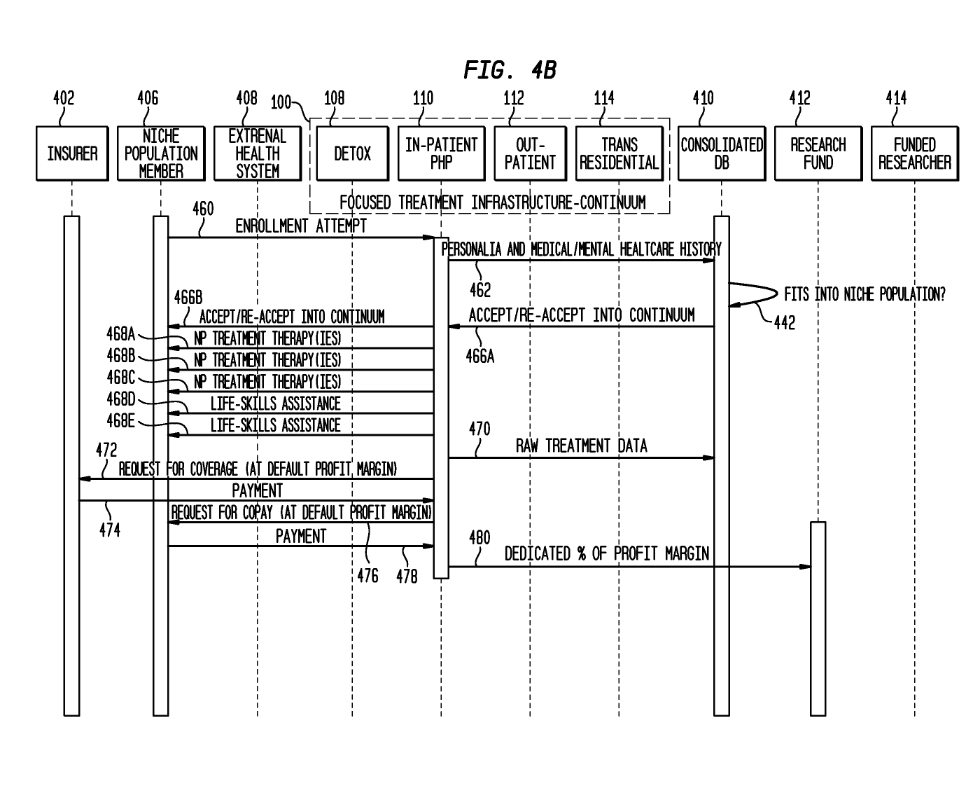

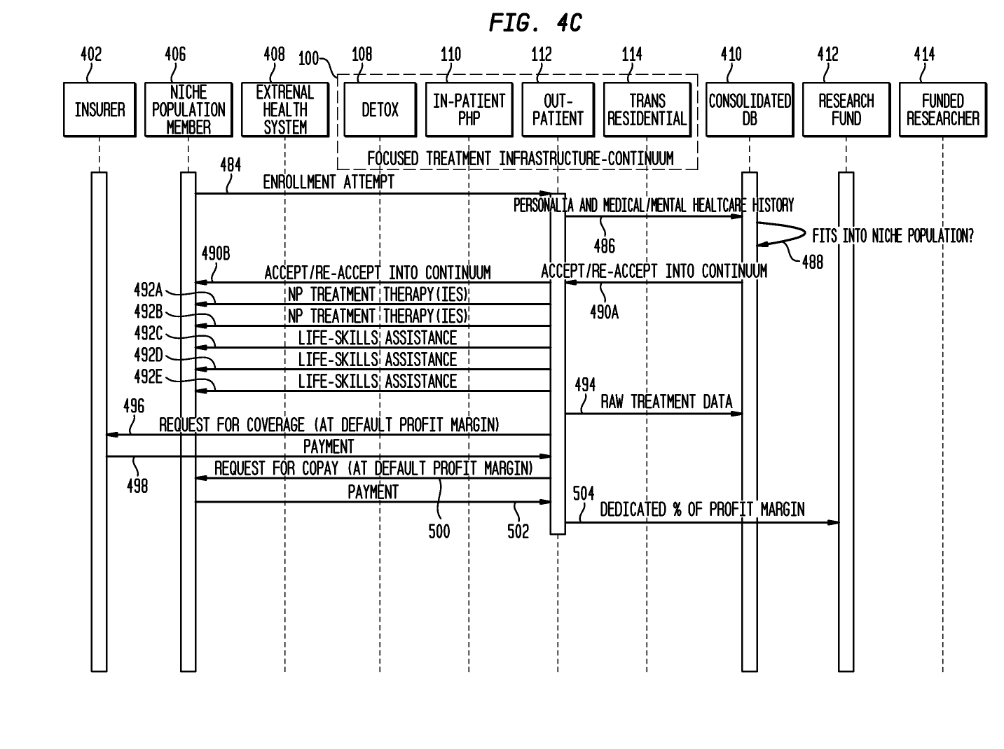

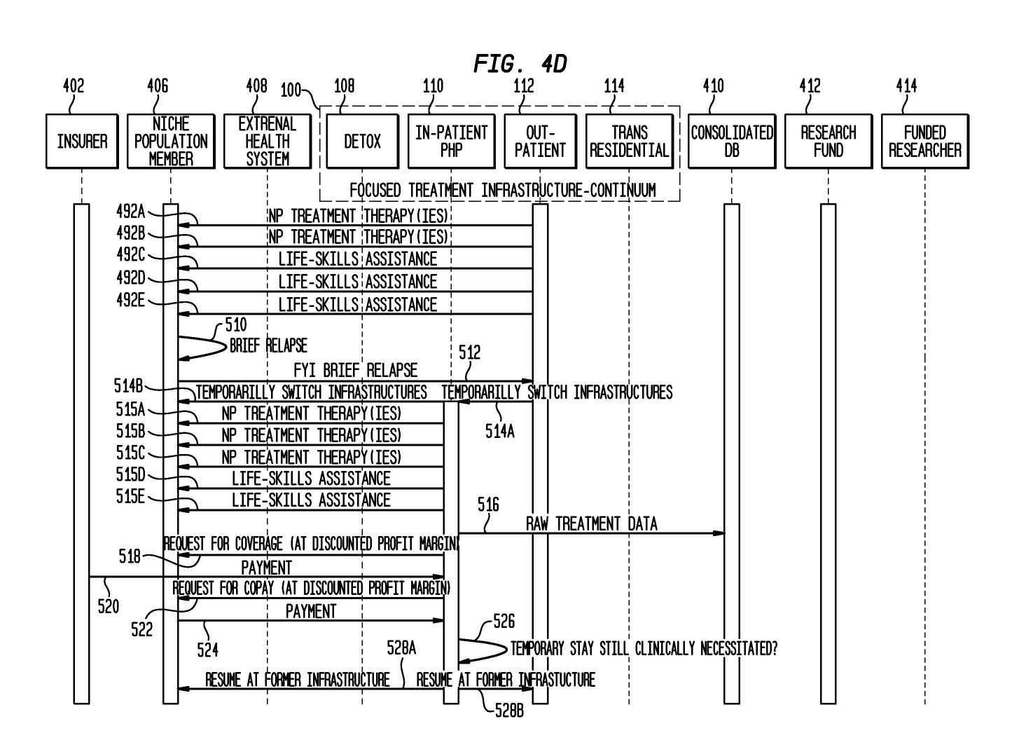

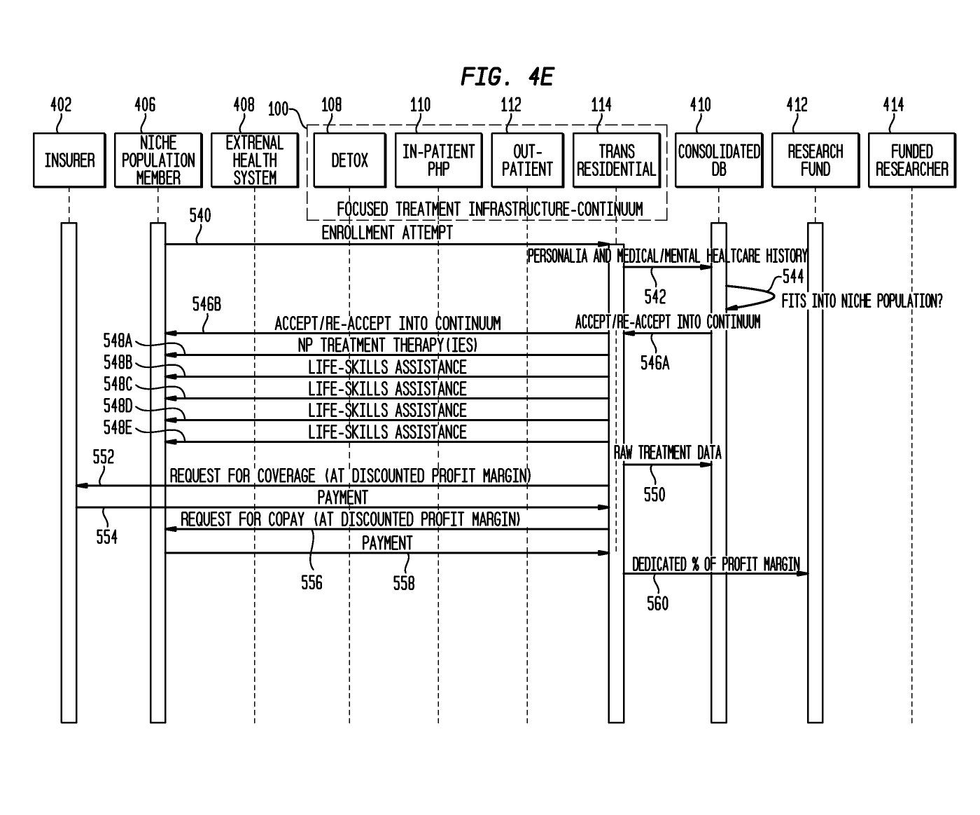

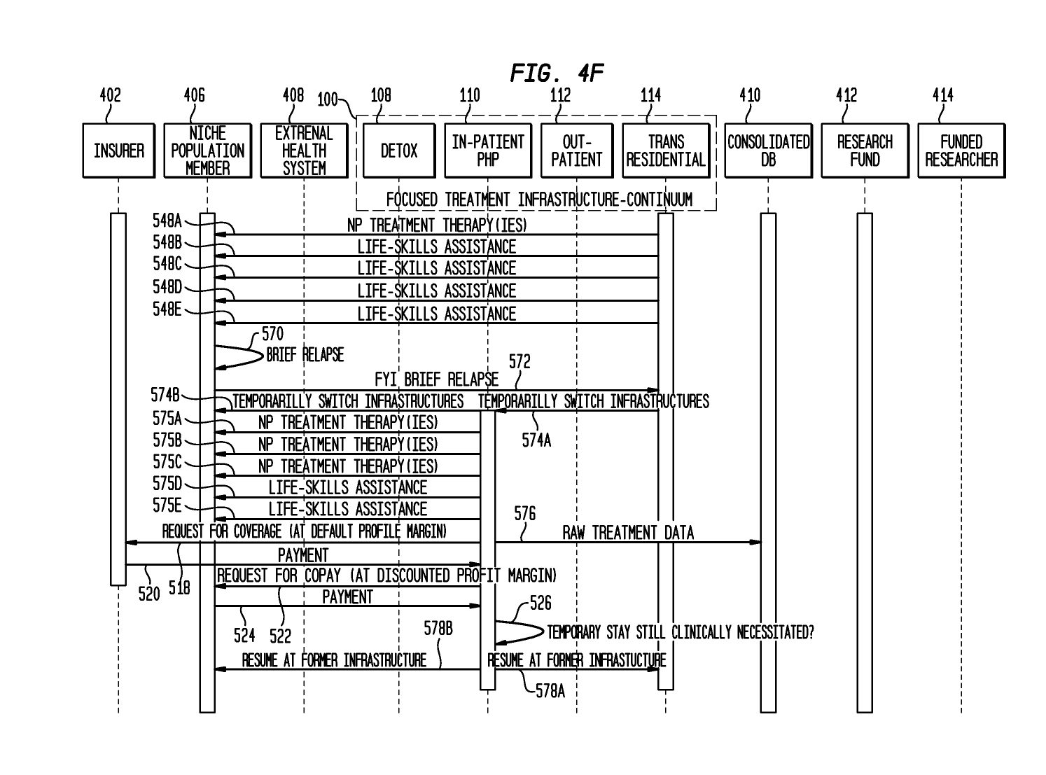

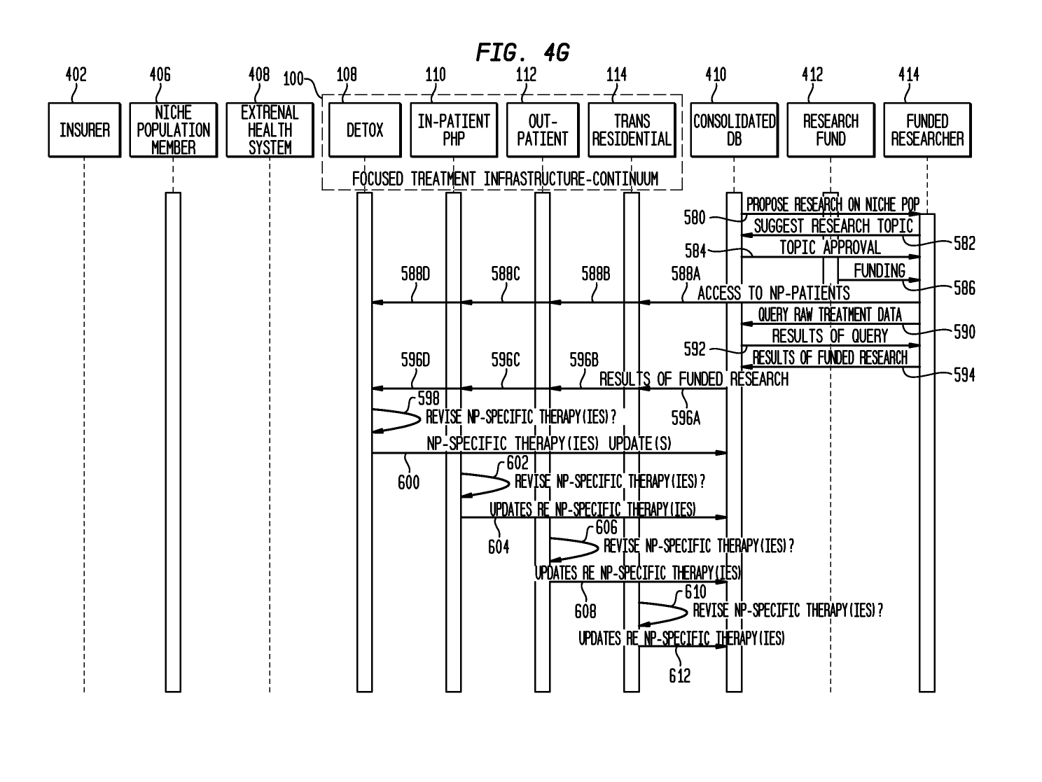

As shown by exploded view 350 in FIG. 3A, engine 300 can be implemented by a computer 352, e.g., a server. Computer 352 can include an interface 354 that has components which can interface to other computers (e.g., networking components, etc.) and to an operator (e.g., man-machine interfacing components such as a display device, a mouse and a keyboard), one or more processors 356 operatively connected to interface 354 and one or memories 358 (e.g., random access memory (RAM) and/or read-only memory (ROM)) operatively connected processor(s) 356. For example, systems 302-306 can be implemented via software running on processor(s) 356 that is stored, e.g., in memory(ies) 358. Also for example, databases 312-320 (and database 410, see the discussion of FIGS. 4A-4G below) can be implemented via memory(ies) 358 and accessed via software running on processor(s) 356 or other devices such as tablet computers, smartphones, etc.

Also illustrated in FIG. 3A, albeit external to engine 300, is a research entity 310. Facilitator system 306 outputs suggestions generates suggestions to perform and/or requests for proposals (RFPs) regarding research for the cluster of traits, and provides the same to research entity 310. Research entity 310 can conduct theoretical research on the cluster and/or empirical research on the cluster by interacting with continuum 100. Data representing results of such theoretical research are provided from research entity 310 to database 320 of theoretical research data. Database 320 provides its data to facilitator system 306.

FIG. 3B illustrates an isolated view of patient selector system 302 of FIG. 3A, according to another embodiment of the present invention.

In FIG. 3B, OPP 104 is illustrated as providing data to database 312, and database 314 is illustrated as storing the data that represents NP 106. Also, patient selector system 302 is illustrated as receiving selection criteria for NP 106 from a database 302 of selection criteria related to the cluster of traits, which can be used to cull OPP 104 to obtain NP 106. Also, selector system is illustrated as providing improvements regarding the selection criteria to database 322. While illustrated as separate databases, databases 312, 314 and 322 can be part of a larger database, e.g., a Medical Record (EMR) system.

FIG. 3C illustrates an isolated view of treatment model developer system 304 of FIG. 3A, according to another embodiment of the present invention.

In FIG. 3C, developer system 304 is illustrated as receiving NP-specific research data (theoretical), other research data and treatment results based upon treatments applied to NP 106, i.e., empirical data. Also in FIG. 3C, NP-specific treatment models are illustrated as being stored in a database 326, which corresponds to database 318 of FIG. 3A. Current treatment models are provided from database 326 to model developer 304, and refinements to the models based upon empirical-based research are provided from model developer 304 back to database 326.

FIG. 3D illustrates an isolated view of empirical-based research facilitator system 306 of FIG. 3A, according to another embodiment of the present invention.

In FIG. 3D, research facilitator 306 is illustrated as receiving NP-specific research data, (theoretical), other research data and treatment results based upon treatments applied to NP 106, i.e., empirical data. Also in FIG. 3D, research facilitator 306 is illustrated as receiving revenue and grant proposals, and outputting grant awards for research on the cluster, suggestions for research to be conducted on the cluster, and requests for proposals (RFPs) for research on the cluster and/or corresponding NP 106.

FIGS. 4A-4G are sequence diagrams illustrating operation of a niche-specific treatment infrastructure continuum, e.g., 100 of FIG. 1, according to another embodiment of the present invention.

Actors in FIGS. 4A-4G include the infrastructures of continuum 100, namely detoxification infrastructure 108, in-patient PHP infrastructure 110; out-patient infrastructure 112; and transitional residential infrastructure 114, a health insurance provider (insurer) 402, a member 406 of NP 106, an external health system 408 (e.g., a clinic on a university campus), a consolidated database 410 (e.g., that includes the databases mentioned above), a research fund 412 and a funded researcher 414.

In FIG. 4A, flow begins at arrow 434, where database 410 queries external health system for data that might reveal there to be patients having one or more traits of a given cluster of traits. At arrow 432, external healthcare system 408 responds to database 410 with results of query. Database 410 uses such data to improve the information that database 410 contains regarding ARP 102. While arrows 430 and 432 are illustrated at the beginning of the sequence diagram of FIG. 4A, it should be understood that arrows could occur at other points in the sequence diagrams of FIGS. 4A-4G.

At arrow 434 of FIG. 4A, a future NP member 406 visits external healthcare system 408 for help with a problem, e.g., substance abuse per se or a problem based in part upon substance abuse albeit, at a time before it has been recognized that NP member 406 has the traits of a given cluster, i.e., at a time before the person is actually a member of NP 106. External healthcare system 408 recognizes that person 406 has one or more traits of the cluster and refers person 406 to niche-specific treatment infrastructure continuum 100 as indicated by arrow 436A going to person 406 and arrow 436B going to database 410 (e.g., as a courtesy/carbon copy). At this point, person 406 is likely a member of ARP 102, and may be a member of OPP 104, and may even be a member of NP 406.

At arrow 438 of FIG. 4A, person 406 makes an application for enrollment (attempts to enroll) in continuum 100, in particular at detoxification infrastructure 108. Detoxification infrastructure 108 communicates the personalia and medical/mental healthcare history of person 406 to database 410 at arrow 440. At arrow 442, database 410 determines if person 406 meets the criteria for enrollment, which includes determining not only that person 406 is a member of OPP 104 but also a member of NP 406. If not a member of NP 406, e.g., (A) if only a member of ARP 102 but not a member of OPP 104 (and thus not a member of NP 106), (B) if only a member of OPP 104 but not a member of NP 106, etc. database 410 would communicate (not illustrated in FIG. 4A) refusal of enrollment, and may also make a referral to a treatment infrastructure better suited to person 406. Upon determining that person 406 fits into NP 106, i.e., has all traits of the given cluster, database 410 communicates a notice of acceptance into continuum 100 via arrow 444A to detoxification infrastructure 108, with detoxification infrastructure 108 relaying the same to person 406 via arrow 444B, where person 406 is now recognized as NP member 406. Alternatively, database 410 can be the source of arrow 444B as well as arrow 444A.

Arrows 446A-446E in FIG. 4A illustrate care given to NP member 406 at detoxification infrastructure 108, i.e., arrows 446A-446E can be referred to generically as care arrows. Of the five care arrows 446A-446E, four (446A-446D) are NP Treatment Therapy(ies) arrows and one (446E) is Life-Skills Assistance. An NP Treatment Therapy is a therapy that is specific to NP 106, i.e., that has been developed specifically for the given cluster, i.e., for NP 106. Likewise, Life-Skills Assistance refers to a service that is specific to NP 106, i.e., that has been developed specifically for the given cluster, i.e., for NP 106. As will become clear in the subsequent discussion of FIGS. 4A-4G, each of infrastructures 108-114 is illustrated with five care arrows going from the given infrastructure to NP member 406. Depending upon the given infrastructure, the ratio of NP Treatment Therapy(ies) arrows to Life-Skills Assistance arrows will vary: a ratio of 4:1 for detoxification infrastructure 108; a ratio of 3:2 for PHP infrastructure 110; a ratio of 2:3 for out-patient infrastructure 112; and a ratio of 1:4 for transitional residential infrastructure 114. It should be understood that the relative ratios illustrated have been chosen so as to reflect the trend lines corresponding to level of care callout 206 and self management callout 208 in FIG. 2. Other combinations of ratios are contemplated.

At arrow 448, detoxification infrastructure 108 reports raw treatment data to database 410, the latter then updating its respective databases accordingly. At arrow 450, detoxification infrastructure 108 requests insurer 402 to pay for (cover) the care provided to NP member 406 (e.g., as reflected by care arrows 446A-446E) by invoicing insurer 402 at the default profit margin of continuum 100. At arrow 452, insurer 402 provides payment to detoxification infrastructure 108. Typically, the health insurance policy under which NP member 406 is covered will require a copay from NP member 406. Assuming such a copay is required, at arrow 454, detoxification infrastructure 108 requests NP member 406 for a copay regarding the care provided to NP member 406 (e.g., as reflected by care arrows 446A-446E) by invoicing NP member 406 at the default profit margin of continuum 100. At arrow 456, NP member 406 provides payment to detoxification infrastructure 108. At arrow 458, detoxification infrastructure 108 transfers a dedicated percentage of the default profit margin to research fund 412.

As treatment of NP member 406 progresses, he or she will reach a point where it is clinically appropriate to move from detoxification infrastructure 108 to PHP infrastructure 110. It is at this point that flow begins in FIG. 4B at arrow 460. It is to be noted, however, that a person can make an application to enter continuum 100 at any of infrastructures 108-114, i.e., not only at detoxification infrastructure 108. Accordingly, arrow 460 can represent either an attempt to enroll anew or re-enroll.

In FIG. 4B, flow begins at arrow 460, where a person 406 (who may already be a member of NP 106 and is re-enrolling, or who is enrolling anew and may or may not be a member of NP 106) makes an application for enrollment/re-enrollment in continuum 100, in particular at PHP infrastructure 110. PHP infrastructure 110 communicates the personalia and medical/mental healthcare history of person 406 to database 410 at arrow 462. At arrow 464, database 410 determines if person 406 meets the criteria for enrollment, which includes determining not only that person 406 is a member of NP 106 by virtue of having been enrolled previously in continuum 100, or if not then determining that person 406 is not only a member of OPP 104 but also a member of NP 406. If not a member of NP 406, e.g., (A) if only a member of ARP 102 but not a member of OPP 104 (and thus not a member of NP 106), (B) if only a member of OPP 104 but not a member of NP 106, etc. database 410 would communicate (not illustrated in FIG. 4B) refusal of enrollment, and may also make a referral to a treatment infrastructure better suited to person 406. Upon determining that person 406 fits into NP 106, i.e., has all traits of the given cluster, database 410 communicates a notice of acceptance into continuum 100 via arrow 466A to PHP infrastructure 110, with PHP infrastructure 110 relaying the same to person 406 via arrow 466B, where person 406 is now re-recognized or recognized anew as NP member 406. Alternatively, database 410 can be the source of arrow 466B as well as arrow 466A.

Care arrows 468A-468E in FIG. 4B illustrate care given to NP member 406 at PHP infrastructure 110. As discussed above, the ratio of NP Treatment Therapy(ies) arrows to Life-Skills Assistance arrows is illustrated as a ratio of 3:2 for PHP infrastructure 110. At arrow 470, PHP infrastructure 110 reports raw treatment data to database 410, the latter then updating its respective databases accordingly. At arrow 472, PHP infrastructure 110 requests insurer 402 to pay for (cover) the care provided to NP member 406 (e.g., as reflected by care arrows 468A-468E) by invoicing insurer 402 at the default profit margin of continuum 100. At arrow 474, insurer 402 provides payment to PHP infrastructure 110. Typically, the health insurance policy under which NP member 406 is covered will require a copay from NP member 406. Assuming such a copay is required, at arrow 476, PHP infrastructure 110 requests NP member 406 for a copay regarding the care provided to NP member 406 (e.g., as reflected by care arrows 468A-468E) by invoicing NP member 406 at the default profit margin of continuum 100. At arrow 478, NP member 406 provides payment to PHP infrastructure 110. At arrow 480, PHP infrastructure 110 transfers a dedicated percentage of the default profit margin to research fund 412.

As treatment of NP member 406 progresses, he or she will reach a point where it is clinically appropriate to move from PHP infrastructure 110 to out-patient infrastructure 112. It is at this point that flow begins in FIG. 4C at arrow 484. It is to be noted, however, that a person can make an application to enter continuum 100 at any of infrastructures 108-114, i.e., not only at detoxification infrastructure 108. Accordingly, arrow 484 can represent either an attempt to enroll anew or re-enroll.

In FIG. 4C, flow begins at arrow 484, where a person 406 (who may already be a member of NP 106 and is re-enrolling, or who is enrolling anew and may or may not be a member of NP 106) makes an application for enrollment/re-enrollment in continuum 100, in particular at out-patient infrastructure 112. Out-patient infrastructure 112 communicates the personalia and medical/mental healthcare history of person 406 to database 410 at arrow 486. At arrow 488, database 410 determines if person 406 meets the criteria for enrollment, which includes determining if person 406 is a member of NP 106 by virtue of having been enrolled previously in continuum 100, or if not then determining that person 406 is not only a member of OPP 104 but also a member of NP 406. If not a member of NP 406, e.g., (A) if only a member of ARP 102 but not a member of OPP 104 (and thus not a member of NP 106), (B) if only a member of OPP 104 but not a member of NP 106, etc. database 410 would communicate (not illustrated in FIG. 4C) refusal of enrollment, and may also make a referral to a treatment infrastructure better suited to person 406. Upon determining that person 406 fits into NP 106, i.e., has all traits of the given cluster, database 410 communicates a notice of acceptance into continuum 100 via arrow 490A to out-patient infrastructure 112, with out-patient infrastructure 112 relaying the same to person 406 via arrow 490B, where person 406 is now re-recognized or recognized anew as NP member 406. Alternatively, database 410 can be the source of arrow 490B as well as arrow 490A.

Care arrows 492A-492E in FIG. 4C illustrate care given to NP member 406 at out-patient infrastructure 112. As discussed above, the ratio of NP Treatment Therapy(ies) arrows to Life-Skills Assistance arrows is illustrated as a ratio of 2:3 for out-patient infrastructure 112. At arrow 494, out-patient infrastructure 112 reports raw treatment data to database 410, the latter then updating its respective databases accordingly. At arrow 496, out-patient infrastructure 112 requests insurer 402 to pay for (cover) the care provided to NP member 406 (e.g., as reflected by care arrows 492A-492E) by invoicing insurer 402 at the default profit margin of continuum 100. At arrow 498, insurer 402 provides payment to out-patient infrastructure 112. Typically, the health insurance policy under which NP member 406 is covered will require a copay from NP member 406. Assuming such a copay is required, at arrow 500, out-patient infrastructure 112 requests NP member 406 for a copay regarding the care provided to NP member 406 (e.g., as reflected by care arrows 492A-492E) by invoicing NP member 406 at the default profit margin of continuum 100. At arrow 502, NP member 406 provides payment to PHP infrastructure 110. At arrow 504, out-patient infrastructure 112 transfers a dedicated percentage of the default profit margin to research fund 412.

Despite making overall positive progress, it is possible that NP member 406 might relapse while receiving treatment at out-patient infrastructure 112 of continuum 100. FIG. 4D is directed to such a contingency. For example, regarding a cluster that has addiction as one of the traits, a brief relapse is a relapse that has not lasted long enough to produce physiological dependence. Typically, treatment for a relapse is provided by PHP infrastructure 110. Alternatively, such treatment may be provided by detoxification infrastructure 108 solely or in part by detoxification infrastructure 108 and in part by PHP infrastructure 110.

In FIG. 4D, flow begins with care arrows 492A-492E, which illustrate care given to NP member 406 at out-patient infrastructure 112, as discussed above. At arrow 510, NP member 406 suffers a brief relapse. At arrow 512, NP member 406 informs out-patient infrastructure 412 of his relapse. In response, out-patient infrastructure 412 informs PHP infrastructure 410 that NP member 406 temporarily needs to change infrastructures via arrow 514A and informs NP member 406 of the same via arrow 514B.

Care arrows 515A-515E in FIG. 4D illustrate care given to relapsing NP member 406 at PHP infrastructure 110. As discussed above, the ratio of NP Treatment Therapy(ies) arrows to Life-Skills Assistance arrows is illustrated as a ratio of 3:2 for PHP infrastructure 110. At arrow 516, PHP infrastructure 110 reports raw treatment data to database 410, the latter then updating its respective databases accordingly. At arrow 518, PHP infrastructure 110 requests insurer 402 to pay for (cover) the care provided to relapsing NP member 406 (e.g., as reflected by care arrows 515A-515E) by invoicing insurer 402. Assuming that relapsing NP member 406 meets criteria for receiving a discount, e.g., including a prerequisite that NP member 406 had been otherwise adhering to all treatment guidelines in for a reasonable period preceding the relapse, then PHP infrastructure 110 will invoice insurer 402 at a discounted profit margin for continuum 100, e.g., at cost. At arrow 520, insurer 402 provides payment to PHP infrastructure 110. Typically, the health insurance policy under which NP member 406 is covered will require a copay from NP member 406. Assuming such a copay is required and assuming that the criteria for receiving a discount has been met, at arrow 522, PHP infrastructure 110 requests NP member 406 for a copay regarding the care provided to relapsing NP member 406 (e.g., as reflected by care arrows 515A-515E) by invoicing NP member 406 at the discounted profit margin of continuum 100. At arrow 524, NP member 406 provides payment to PHP infrastructure 110. At arrow 526, PHP infrastructure 110 determines if it is clinically necessitated for NP member 406 to continue undergoing treatment at PHP infrastructure 110. If not, then PHP infrastructure 110 informs out-patient infrastructure 112 and NP member 406 via arrows 528A and 528B, respectively, that treatment of NP member 406 should resume at out-patient infrastructure 112.

As treatment of NP member 406 progresses, he or she will reach a point where it is clinically appropriate to move from out-patient infrastructure 112 to transitional residential infrastructure 114. It is at this point that flow begins in FIG. 4E at arrow 540. It is to be noted, however, that a person can make an application to enter continuum 100 at any of infrastructures 108-114, i.e., not only at detoxification infrastructure 108. Accordingly, arrow 540 can represent either an attempt to enroll anew or re-enroll.

In FIG. 4E, flow begins at arrow 540, where a person 406 (who may already be a member of NP 106 and is re-enrolling, or who is enrolling anew and may or may not be a member of NP 106) makes an application for enrollment/re-enrollment in continuum 100, in particular at out-transitional residential infrastructure 114. Transitional residential infrastructure 114 communicates the personalia and medical/mental healthcare history of person 406 to database 410 at arrow 542. At arrow 544, database 410 determines if person 406 meets the criteria for enrollment, which includes determining if person 406 is a member of NP 106 by virtue of having been enrolled previously in continuum 100, or if not then determining that person 406 is not only a member of OPP 104 but also a member of NP 406. If not a member of NP 406, e.g., (A) if only a member of ARP 102 but not a member of OPP 104 (and thus not a member of NP 106), (B) if only a member of OPP 104 but not a member of NP 106, etc. database 410 would communicate (not illustrated in FIG. 4E) refusal of enrollment, and may also make a referral to a treatment infrastructure better suited to person 406. Upon determining that person 406 fits into NP 106, i.e., has all traits of the given cluster, database 410 communicates a notice of acceptance into continuum 100 via arrow 546A to transitional residential infrastructure 114, with transitional residential infrastructure 114 relaying the same to person 406 via arrow 546B, where person 406 is now re-recognized or recognized anew as NP member 406. Alternatively, database 410 can be the source of arrow 546B as well as arrow 546A.

Care arrows 548A-548E in FIG. 4E illustrate care given to NP member 406 at transitional residential infrastructure 114. As discussed above, the ratio of NP Treatment Therapy(ies) arrows to Life-Skills Assistance arrows is illustrated as a ratio of 1:4 for transitional residential infrastructure 114. At arrow 550, transitional residential infrastructure 114 reports raw treatment data to database 410, the latter then updating its respective databases accordingly. At arrow 552, transitional residential infrastructure 114 requests insurer 402 to pay for (cover) the care provided to NP member 406 (e.g., as reflected by care arrows 548A-548E) by invoicing insurer 402 at the default profit margin of continuum 100. At arrow 554, insurer 402 provides payment to out-patient infrastructure 112. Typically, the health insurance policy under which NP member 406 is covered will require a copay from NP member 406. Assuming such a copay is required, at arrow 556, transitional residential infrastructure 114 requests NP member 406 for a copay regarding the care provided to NP member 406 (e.g., as reflected by care arrows 548A-548E) by invoicing NP member 406 at the default profit margin of continuum 100. At arrow 558, NP member 406 provides payment to transitional residential infrastructure 114. At arrow 560, transitional residential infrastructure 114 transfers a dedicated percentage of the default profit margin to research fund 412.

Despite making overall positive progress, it is possible that NP member 406 might relapse while receiving treatment at transitional residential infrastructure 114 of continuum 100. FIG. 4F is directed to such a contingency.

In FIG. 4F, flow begins with care arrows 548A-548E, which illustrate care given to NP member 406 at transitional residential infrastructure 114, as discussed above. At arrow 570, NP member 406 suffers a brief relapse. At arrow 572, NP member 406 informs out-patient infrastructure 412 of his relapse In response, transitional residential infrastructure 114 informs PHP infrastructure 410 that NP member 406 temporarily needs to change infrastructures via arrow 574A and informs NP member 406 of the same via arrow 574B.

Care arrows 575A-575E in FIG. 4F illustrate care given to relapsing NP member 406 at PHP infrastructure 110. As discussed above, the ratio of NP Treatment Therapy(ies) arrows to Life-Skills Assistance arrows is illustrated as a ratio of 3:2 for PHP infrastructure 110. At arrow 576, PHP infrastructure 110 reports raw treatment data to database 410, the latter then updating its respective databases accordingly. At arrow 518, PHP infrastructure 110 requests insurer 402 to pay for (cover) the care provided to relapsing NP member 406 (e.g., as reflected by care arrows 575A-575E) by invoicing insurer 402. Assuming that relapsing NP member 406 meets criteria for receiving a discount, e.g., including a prerequisite that NP member 406 had been otherwise adhering to all treatment guidelines in for a reasonable period preceding the relapse, then PHP infrastructure 110 will invoice insurer 402 at a discounted profit margin for continuum 100, e.g., at cost. At arrow 520, insurer 402 provides payment to PHP infrastructure 110. Typically, the health insurance policy under which NP member 406 is covered will require a copay from NP member 406. Assuming such a copay is required and assuming that the criteria for receiving a discount has been met, at arrow 522, PHP infrastructure 110 requests NP member 406 for a copay regarding the care provided to relapsing NP member 406 (e.g., as reflected by care arrows 575A-575E) by invoicing NP member 406 at the discounted profit margin of continuum 100. At arrow 524, NP member 406 provides payment to PHP infrastructure 110. At arrow 526, PHP infrastructure 110 determines if it is clinically necessitated for NP member 406 to continue undergoing treatment at PHP infrastructure 110. If not, then PHP infrastructure 110 informs transitional residential infrastructure 114 and NP member 406 via arrows 578A and 578B, respectively, that treatment of NP member 406 should resume at out-patient infrastructure 112.

As discussed above, infrastructures 108, 110, 112 and 114 transfer a dedicated percentage of the default profit margin to research fund 412 via arrows 458, 480, 504 and 560, respectively. FIG. 4G is directed, in part, towards what is done with research fund 412.

In FIG. 4G, flow begins at arrow 580, where database 410 proposes to researcher 414 that research should be conducted on the given cluster of traits and/or on NP 106. Alternatively or in addition, database 410 can make a request for proposal (RFP) to research 414 (and optionally other researchers not illustrated in FIG. 4G) for research to be conducted on the given cluster of traits and/or on NP 106. At arrow 582, researcher 414 submits a specific topic for research to be conducted on the given cluster of traits and/or on NP 106. Such research can be theoretical and/or empirical. If criteria for acceptable research are met, then database 410 communicates approval of the topic to researcher 414 via arrow 584. At arrow 586, research funds are transferred from research fund 412 to researcher 414, thereby transforming the researcher into a funded researcher. At arrows 588A-588D, researcher 414 is granted access to each of infrastructures 114, 112, 110 and 108, respectively, in order to facilitate empirical research on NP 106. At arrow 590, researcher 414 queries database 410 for information regarding the given cluster of traits and/or NP 106, e.g., for access to the raw treatment data accumulated at least in part via feedback arrows 448, 470, 494, 516, 550 and 576. At arrow 592, database 410 provides results of the query to researcher 414.

At arrow 594 of FIG. 4G, researcher 414 communicates the results of his research to database 410. At arrows 596A-596D, database 410 informs infrastructures 114, 112, 110 and 108, respectively, of the results of the research.

At arrow 598 of FIG. 4G, detoxification infrastructure 108 determines whether one or more of its NP-specific therapies should be updated based upon the research update of arrow 596D, and does so if need be. At arrow 600, detoxification infrastructure 108 notifies database 410 of any updates made to its therapies, the latter then updating its respective databases accordingly. At arrow 602, PHP infrastructure 110 determines whether one or more of its NP-specific therapies should be updated based upon the research update of arrow 596C, and does so if need be. At arrow 604, PHP infrastructure 110 notifies database 410 of any updates made to its therapies, the latter then updating its respective databases accordingly. At arrow 606, out-patient infrastructure 112 determines whether one or more of its NP-specific therapies should be updated based upon the research update of arrow 596B, and does so if need be. At arrow 608, out-patient infrastructure 112 notifies database 410 of any updates made to its therapies, the latter then updating its respective databases accordingly. At arrow 610, transitional residential infrastructure 114 determines whether one or more of its NP-specific therapies should be updated based upon the research update of arrow 596A, and does so if need be. At arrow 612, transitional residential infrastructure 114 notifies database 410 of any updates made to its therapies, the latter then updating its respective databases accordingly.

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Furthermore, this patent does not seek to describe or limit the subject matter covered by the claims in any particular part, paragraph, statement or drawing of the application. The subject matter should be understood by reference to the entire specification, all drawings and each claim.

While various embodiments of the present invention have been described above, it should be understood that they have been presented by way of example only, and not limitation. Different arrangements of the components depicted in the drawings or described above, as well as components and steps not shown or described are possible. Similarly, some features and subcombinations are useful and may be employed without reference to other features and subcombinations. It will be apparent to persons skilled in the relevant art that various changes in form and detail can be made therein without departing from the spirit and scope of the invention. Accordingly, the present invention is not limited to the embodiments described above or depicted in the drawings, and various embodiments and modifications can be made without departing from the scope of the claims below.

What is claimed is:

1. A treatment-continuum system for treating a cluster of traits, the system comprising:
two or more treatment infrastructures each providing a specific level of treatment, adapted for the cluster of traits, to a corresponding niche population (NP) of persons, said treatment defined by a treatment model developed using data resulting from empirical-based research for the cluster and upon said NP.

2. The system of claim 1, wherein:
the system comprises the two or more treatment infrastructures each implements a different level of treatment, with each such treatment level defined by a level of care provided to a patient and an expected level of patient independence.

3. The system of claim 2, wherein the two or more treatment infrastructures includes:
an in-patient partial hospitalization program (PHP), and
a transitional residential infrastructure wherein residents thereof are members of said NP.

4. The system of claim 3, wherein the in-patient PHP infrastructure includes:
a first treatment facility specializing primarily in the traits cluster,
a first arsenal of therapies selected for the traits cluster, and
an in-patient residential facility wherein residents thereof are members of said NP.

5. The system of claim 4, wherein at least one of the in-patient PHP infrastructure and the transitional residential infrastructure includes:
a second arsenal of life-skills assistance services available to members of said NP.

6. The system of claim 3, wherein the plurality of treatment infrastructures further includes:
an out-patient infrastructure including,
access to the first treatment facility on an out-patient basis, and
a second arsenal of therapies selected for the traits cluster;
wherein users of the out-patient infrastructure are NP members.

7. The system of claim 6, wherein:
the second arsenal and the first arsenal at most only insubstantially overlap.

8. The system of claim 3, wherein the plurality of treatment infrastructures further includes:
a detoxification infrastructure including,
a second treatment facility specializing primarily in treating at least one of emergent and urgent symptoms of the traits cluster, and
a third arsenal of therapies selected for the traits cluster; and
wherein users of the detoxification infrastructure are NP members.

9. The system of claim 1, further comprising:
a business engine to support the one or more treatment infrastructures.

10. The system of claim 9, wherein:
said business engine includes,
a database including data characterizing a general population of people;
said business engine further includes at least one of the following,
a patient selection system including,
a first processor configured to do at least the following,
identify an original population of persons (OPP) suffering from traits of the cluster including,
at least one Axis I disorder, and
at least one Axis IV problem; and
select the NP of persons from said OPP based on selection criteria corresponding to additional traits of the cluster including at least two additional demographic attributes;
a treatment model development system including,
a second processor configured to do at least the following,
develop treatment models for performing a specific level of treatment adapted for the traits cluster and adapted to said NP, wherein said treatment models are developed based on data resulting from previously performed treatment administered to said NP and empirical-based research conducted for the traits cluster and for said NP; and
a research facilitation system including,
a third processor configured to do at least the following,
generate suggestions to research entities to perform empirical-based research related to the traits cluster and upon the NP, wherein said suggested research is based on data resulting from previously-performed research and results of treatment administered to members of said NP.

11. A patient selection system comprising:
a database including data characterizing a general population of people;
a processor configured to do at least the following,
identify an original population of persons (OPP) suffering from a cluster of traits; and
select a niche population (NP) of persons from said OPP based on selection criteria including at least one confounding attribute of a member of said OPP

12. The system of claim 11, wherein the traits of the cluster include:
at least one Axis I disorder;
at least one Axis IV problem; and
at least two additional demographic attributes.

13. The system of claim 12, wherein the at least one confounding attribute includes at least one of:
member age range;
member sex;
type of health insurance covering; and
enrollment in one of a degree-granting institution, a professional certification program of studies and a trade-school program of studies.

14. The system of claim 11, wherein said processor is operable to revise at least one of said characteristic features of said traits cluster and said selection criteria based on data generated from previously-performed research on and treatment results from the NP.

15. A treatment model development system comprising:
a database including data characterizing an original population of persons (OPP) suffering from a cluster of traits and a niche population (NP) amongst the OPP;
a processor configured to do at least the following,
develop treatment models for performing a specific level of treatment adapted for the cluster of traits and adapted to said NP, wherein said treatment models are developed based on data resulting from previously performed treatment administered to said NP and empirical-based research conducted for the cluster and upon said NP.

16. The system of claim 15, wherein the previously performed treatment administered to said NP is administered in one or more of a plurality of treatment infrastructures each implementing a different level of treatment, with each such treatment level defined by a level of care provided to a patient and an expected level of patient independence, the plurality representing a niche-specific-treatment infrastructure-continuum.

17. A research facilitation system comprising:
a database including data characterizing an original population of persons (OPP) suffering from a cluster of traits and a niche population (NP) amongst the OPP;
a processor configured to do at least the following,
generate suggestions to research entities to perform empirical-based research related to the cluster and upon the NP, wherein said suggested research is based on data resulting from previously-performed research and results of treatment administered to members of said NP.

18. The system of claim 17, wherein:
at least one of said research entities is part of an academic institution located in a geographic region; and
wherein the previously performed treatment administered to said NP is administered in one or more of a plurality of treatment infrastructures located in the geographic region.

19. The system of claim 18, wherein:
each of treatment infrastructures is configured to implement a different level of treatment, with each such treatment level defined by a level of care provided to a patient and an expected level of patient independence, the plurality representing a niche-specific-treatment infrastructure-continuum.

20. The system of claim 19, wherein at least one of said one or more treatment infrastructures is physically isolated from a geographic center of mass of the OPP.

21. A method of treating a cluster of traits, the method comprising:
identifying an original population of persons (OPP) suffering from the cluster of traits including,
at least one Axis I disorder, and
at least one Axis IV problem;
culling the OPP according to at least two additional demographic attributes thereby to form a niche population (NP); and
matching the NP with a treatment infrastructure specialized for treating the cluster.

22. The method of claim 21, wherein the culling includes:
filtering the OPP according to at least one confounding attribute.

23. The method of claim 22, wherein the at least one confounding attribute includes at least one of:
member age range;
member sex;
type of health insurance covering; and
enrollment in one of a degree-granting institution, a professional certification program of studies and a trade-school program of studies.

24. The method of claim 22, wherein:
the at least one Axis I and Axis IV disorder is a substance-related disorder; and
the at least one Axis IV demographic attribute relates to at least one of a given primary support group, a given social environment, a given educational adversity, a given economic adversity, a given occupation.

25. The method of claim 24, wherein the at least one confounding attribute includes:
enrollment in one of a degree-granting institution, a professional certification program of studies and a trade-school program of studies.

26. The method of claim 25, wherein the at least one confounding attribute includes:
age in a range of about 18 years old to about 29 years old.

27. The method of claim 21, wherein:
the identifying includes,
obtaining access to a patient database of an external heath system outside the specialized infrastructure,
querying the database for patients that exhibit minimal features of the traits cluster, and
receiving results of the querying; and
the OPP is based upon the results.

28. The method of claim 21, further comprising:
providing the treatment infrastructure, including
providing a niche-specific treatment infrastructure-continuum of varying treatment levels, the infrastructure-continuum including,
providing an in-patient partial hospitalization program (PHP) infrastructure including,
a first treatment facility specializing primarily in the traits cluster,
a first arsenal of therapies selected for the traits cluster, and
an in-patient residential facility wherein residents thereof are members of the NP, and
providing a transitional residential infrastructure wherein residents thereof are members of the NP.

29. The method of claim 28, wherein at least one of the in-patient PHP infrastructure, the out-patient infrastructure and the transitional residential infrastructure includes:
a second arsenal of life-skills assistance services available to members of the NP.

30. The method of claim 29, wherein:
an educational program includes at least one of a program of studies provided by a degree-granting institution, a professional certification program of studies and a trade-school program of studies; and
the second arsenal includes at least one of,
a service that assists with enrollment in a first instance of the educational program,
a service that assists with transferring credits from a second instance of the educational program to a third instance of the educational program,
a service that assists with registering for one or more classes in a fourth instance of the educational program,
a service that assists with registering for remedial classes to be taken in preparation for requesting enrollment in a fifth instance of the educational program;
a service that assists with registering for a general educational development (GED) test;
a service that assists with academic tutoring;
a service that assists with standardized-test preparation;
a service that assists with obtaining a Visa;
a service that assists with identifying extracurricular activities; and
a service that assists with involvement in a selected one or more of the identified extracurricular activities and
a service that assists with placement in sober dormitories upon completion of a course of treatment associated with the infrastructure-continuum.

31. The method of claim 28, wherein the providing of the niche-specific treatment infrastructure continuum further includes:
providing an out-patient infrastructure including,
access to the first treatment facility on an out-patient basis, and
a second arsenal of therapies selected for the traits cluster;
wherein users of the out-patient infrastructure are NP members.

32. The method of claim 31, wherein:
the second arsenal and the first arsenal at most only insubstantially overlap.

33. The method of claim 28, wherein the providing of the niche-specific treatment infrastructure continuum further includes:
providing a detoxification infrastructure including,
a second treatment facility specializing primarily in treating at least one of emergent and urgent symptoms of the traits cluster, and
a third arsenal of therapies selected for the traits cluster; and
wherein users of the detoxification infrastructure are OPP members.

34. The method of claim 28, further comprising:
identifying an at-risk population (ARP) having features relevant to the traits cluster; and
determining a geographic center of mass of the ARP; and
wherein the providing of the in-patient PHP infrastructure includes,
locating the first treatment facility and the in-patient residential facility within walking distances of the geographic center of mass.

35. The method of claim 34, wherein the providing of the in-patient PHP infrastructure further includes:
locating the first treatment facility and the in-patient residential facility within walking distance of each other.

36. The method of claim 34, wherein the providing of the transitional residential infrastructure further includes:
locating the transitional residential infrastructure within walking distance of the geographic center of mass.

37. The method of claim 34, wherein features of the ARP include:
the at least one Axis IV demographic attribute of the OPP; and
at least two confounding attributes.

38. The method of claim 37, wherein the at least two confounding attributes include:
an age range;
sex;
type of health insurance; and
enrollment in one of a degree-granting institution, a professional certification program of studies and a trade-school program of studies.

39. A method of facilitating research on a cluster of traits, the method comprising:
defining a cluster of traits as including,
at least one Axis I disorder,
at least one Axis IV problem, and
at least two additional demographic attributes;
treating a niche population (NP) of cluster sufferers with an arsenal of therapies;
receiving compensation for the treating;
dedicating a portion of the compensation to a research-fund; and
drawing upon the research-fund to fund research on the cluster by a research entity.

40. The method of claim 39, further comprising:
collecting raw data about the NP in a database; and
granting access by the research entity to the database.

41. The method of claim 39, further comprising:
granting access by the research entity to the NP.

42. A method of invoicing for treatment of a cluster of traits, the method comprising:
defining the cluster of traits as including,
at least one Axis I disorder,
at least one Axis IV problem, and
at least two additional demographic attributes;
treating a niche population (NP) of cluster sufferers with an arsenal of therapies;
wherein a member of the NP progresses through a continuum of treatment infrastructures in which patient recovery is characterized by a decreasing level of NP-specific therapies and a corresponding increasing level of NP-specific life-skills assistance;
invoicing, during progression through the continuum, at a default profit margin; and
invoicing, during a relapse, at a discounted profit margin.

43. The method of claim 42, wherein:
members of the NP are covered by health insurance policies;
the invoicing is directed to members' health insurance policies; and
the method further comprises:
receiving corresponding payments from the health insurance policies; and
wherein cluster research is thereby funded by insurance proceeds.

44. The method of claim 42, wherein:
the discount is at cost.

45. The method of claim 44; wherein the determining the NP includes:
identifying an original population of persons (OPP) suffering from the traits cluster;
culling the OPP to form the NP.

46. The method of claim 45; wherein the culling includes:
filtering the OPP so as to facilitate the NP being substantially homogenous in terms of a set of confounding attributes.

47. A niche-specific treatment infrastructure continuum comprising:
two or more treatment facilities each providing a specific level of treatment for a cluster of traits and to a corresponding niche population, said treatment defined by a treatment model developed using empirical-based research data resulting from research for the specific disorder class and niche population.

48. A research facilitator configured to generate suggestions to at least one of research facilities and researchers to perform empirical-based research specific to at least one of a cluster of traits and a corresponding niche population, wherein said suggested research is based on data resulting from previously-performed research and treatment conducted for the cluster of traits and upon the corresponding niche population.

49. A patient selector configured to select a niche patient population from a population of potential patients based on selection criteria specifying a cluster of traits, the traits including at least one Axis I disorder, at least one Axis IV problem, and at least two additional demographic attributes.

50. A treatment model developer configured to develop treatment models for performing a specific level of treatment for a cluster of traits and a corresponding niche population, wherein said treatment model is developed based on data resulting from previously performed treatment and empirical-based research conducted for the cluster of traits and upon the corresponding niche population.
